(19) United States
(12) Patent Application Publication
(10) Pub. No.: US 2021/0142169 A1
(43) Pub. Date: May 13, 2021

(54) PREDICTION INTERPRETATION

(71) Applicant: ACCENTURE GLOBAL SOLUTIONS LIMITED, Dublin (IE)

(72) Inventors: Tanusree DE, Bangalore (IN); Prasenjit GIRI, Kolkota (IN); Arati DEO, Bangalore (IN); AhmedUvesh Ismail MEVAWALA, Kurla West (IN); Ramyasri NEMANI, Rayavaram Mandal (IN)

(73) Assignee: ACCENTURE GLOBAL SOLUTIONS LIMITED, Dublin (IE)

(21) Appl. No.: 17/035,229

(22) Filed: Sep. 28, 2020

(30) Foreign Application Priority Data
Nov. 8, 2019 (IN) 201911045541

(51) Int. Cl. G06N 3/08; G06N 3/04; G06N 20/20; G06N 5/00; G06N 5/04

(52) U.S. Cl. CPC G06N 3/08; G06N 3/04; G06N 5/04; G06N 5/003; G06N 20/20

(57) ABSTRACT

Examples of a prediction explanation system are be provided. The system may obtain a first data record comprising multiple case instances and a first data record neural network providing multiple predictions, each prediction being associated with a case instance. Each case instance may be analyzed to determine a corresponding hidden neuron contribution score, which may be used for clustering the cases instances into multiple instance clusters. For each instance cluster, a decision tree model may be generated, where a decision tree model comprises an explanation for a prediction associated with the case instance in the instance cluster. For a second data record obtained by the system, a second data index comprising a cluster mapping score assigned to each decision tree model may be determined. Based on the decision trees model with a highest cluster mapping score, a second data prediction output providing an explanation for a prediction may be generated.

### PRIORITY CLAIM

This application claims priority to Indian provisional patent application number 201911045541, filed on Nov. 8, 2019, the disclosure of which is incorporated by reference in its entirety.

### BACKGROUND

The importance of Artificial Intelligence (AI) as a managerial tool has increased significantly in recent times. Currently, AI may be deployed for a plethora of operations in an organization. However, a big challenge in leveraging AI based technology effectively may be that many AI models, for example, deep neural networks may be incomprehensible to humans. In deep neural networks, as the inputs are combined and recombined in various hidden layers, the complexity increases. Therefore, it becomes increasingly difficult to interpret the complex flow of information that leads to the final outcome. This lack of transparency in a deep learning model's reasoning may be termed as a “Black Box” problem. As a result, deep learning models may not be potentially utilized in many applications when there is a need to understand the rationale behind the prediction to guide downstream actions or to ensure compliance and lack of bias.

Available human-interpretable approaches may aim to find trends and patterns to map inputs to the network predicted output. However, the available approaches may not capture and explain the flow of information within the black box deep neural network for each variable. Such information may be insufficient in many enterprise domains, such as, military, finance and accounting or healthcare domain, where reasoning process has to be clearly documented. And when a claim is rejected, it may be mandatory that an explanation is offered. Additionally, available techniques may fail to provide a human-interpretable explanation for the AI model prediction at an individual instance level irrespective of the complexities of the underlying models such as, for example, the deep neural network models. Furthermore, such approaches may require human intervention for prediction validation to make an AI system trustworthy and actionable.

### BRIEF DESCRIPTION OF DRAWINGS

FIG. 1 illustrates a diagram for a prediction interpretation system, according to an example embodiment of the present disclosure.

FIG. 2 illustrates various components of the prediction interpretation system, according to an example embodiment of the present disclosure.

FIG. 3 illustrates a flow diagram for generating an explanation for a predicted outcome of a new instance, according to an example embodiment of the present disclosure.

FIG. 4 illustrates a flow diagram depicting a hybrid approach for training the prediction interpretation system for a trained deep neural network, according to an example embodiment of the present disclosure.

FIG. 5 illustrates a flow diagram for training an explanation model and generating decision rules that may provide a human-interpretable explanation for a prediction, according to an example embodiment of the present disclosure.

FIG. 6 illustrates a flow diagram for generating prediction explanation, according to an example embodiment of the present disclosure.

FIG. 7 illustrates a flow diagram for implementing a TREPAN technique for prediction interpretation, according to an example embodiment of the present disclosure.

FIG. 8 illustrates a pictorial representation of a decision tree generated by the prediction interpretation system, according to an example embodiment of the present disclosure.

FIG. 9 illustrates a hardware platform for the implementation of the prediction interpretation system, according to an example embodiment of the present disclosure.

FIGS. 10A and 10B illustrate a process flowchart for the generation of prediction explanation, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered.

Typically, interpretability required from an AI system may be of different types such as, for example, a global surrogate interpretable model, a local surrogate interpretable model, a model agnostic interpretability, and a model-specific interpretability. The global surrogate model may be an interpretable model that may be trained to approximate the predictions of the black-box machine learning model. The local surrogate model may be used to explain individual predictions of the black-box machine learning models. In various instances to guide action, the explanation at a case level may be pertinent. For example, two individuals may have a high probability of defaulting a payment but for completely different reasons, which would constitute different feature variables. The model agnostic interpretability may be configured to explain any model by treating an original model as a black box. This provides flexibility to explain different feature variables. The model-specific explanation considers the structure of the model to derive an explanation for the prediction. The interpretability based approaches may aim to find trends and patterns to map inputs to the network predicted output. However, such approaches fail to explain the flow of information within the black box deep neural network for each variable. Furthermore, available techniques may fail to provide a human-interpretable explanation for the AI model prediction at an individual instance level.

The present disclosure describes a system and method for the generation of an interpretation for a prediction made by an artificial intelligence (AI) model including a prediction explanation system (PES). The prediction explanation system (referred to as “system” hereinafter) may be used for enabling the generation of human interpretable explanations (or, reasons codes) for a deep neural network model-based outcome at an individual instance level. The system may make an AI system more trustworthy and actionable. The system may include a hybrid approach for explaining predictions of a deep neural network model that may combine clustering of a neural network hidden layer representation by grouping similar relationships learned by a trained neural network. The system may deploy a decision tree method on trained neural network prediction outcomes at a cluster level to extract a set of reason codes or decision rules for explaining the neural network prediction outcome at an instance level. The system may enable generation of human interpretable explanations (or, reasons codes) for a deep neural network model-based outcome at an individual instance level. The system approach may enable capture and explain the flow of information within a deep neural network at an instance level taking into consideration different input features that may have a similar pattern within each cluster of instances and the pattern is distinct from patterns in other cluster of instances.

The system may include a processor, a data cluster assembler, an explanation model assembler, and a data predictor and explanator. The processor may be coupled to the data cluster assembler, the explanation model assembler, and the data predictor and explanator. The data cluster assembler may receive a first data record from a user. The first data record may include one or more case instances pertaining to processing a case result prediction requirement associated with a case result prediction operation. The case instances may include a set of instances relevant to the case result prediction operation. The data cluster assembler may receive from the user a first data record neural network associated with the first data record and comprising one or more predictions. Each of the predictions to be associated with a case instance from the plurality of case instances.

The data cluster assembler may implement an artificial intelligence component to assign a hidden neuron contribution score for each of the case instances to the corresponding first data record neural network prediction. The hidden neuron contribution score, for a case instance, may be indicative of relative contribution of each hidden neuron of a last hidden layer to an output layer of the neural network for the case instance. The data cluster assembler may evaluate the hidden neuron contribution scores for assigning a similarity value to each of the plurality of case instances. Each of the plurality of case instances may be grouped or clustered, based on corresponding similarity values for identifying a plurality of instance clusters.

The explanation model assembler may implement a first cognitive learning operation to create a decision tree at each of the plurality of instance clusters. The decision tree may include a visualization of each of the plurality of predictions associated with a corresponding case instance from case instances. The explanation model assembler may implement the first cognitive learning operation to also determine a decision tree model at each of the plurality of instance clusters. A decision tree model for an instance cluster may include an explanation for a corresponding prediction associated with the case instances in the instance cluster. The explanation may include, for instance, a justification, a reasoning, a criteria, or a content explaining why's and/or how's associated with the prediction in a human interpretable manner.

The data predictor and explanator may receive a second data record from the user. The second data record may be comprising a second data record case instance relevant to the case result prediction operation. The data predictor and explanator may implement a second cognitive learning operation to analyze the second data record with respect to each of the decision tree models to determine a second data index. The second data index may include a cluster mapping score assigned to each of the decision tree models based on a mapping proximity with the second data record. The data predictor and explanator may implement a second cognitive learning operation to evaluate the cluster mapping score for each of the plurality of decision tree models to determine a decision tree model from the decision tree models with the highest cluster mapping score. The data predictor and explanator may generate a second data prediction output comprising the decision tree model with a highest cluster mapping score to resolve the case result prediction requirement.

For the sake of brevity and technical clarity, the description of the prediction explanation system may be explained with reference to few example embodiments, however, it will be appreciated that the principles described here may be applies to a variety of other scenarios for generation of an explanation of a prediction derived from a neural network model.

Accordingly, the present disclosure aims to provide a prediction explanation system that may account for the various factors mentioned above, amongst others, to comprehensible human-interpretable explanation for a deep neural network-based prediction for in an efficient, and cost-effective manner. Furthermore, the present disclosure may categorically analyze various parameters that may have an impact on generating an explanation for an outcome predicted by a neural network.

FIG. 1 illustrates a prediction explanation system 110 (hereinafter referred to as system 110), according to an example implementation of the present disclosure. In an example, the system 110 may include a processor 120, a data cluster assembler 130, an explanation model assembler 140, and a data predictor and explanator 150. The processor 120 may be coupled to the data cluster assembler 130, the explanation model assembler 140, and the data predictor and explanator 150.

The data cluster assembler 130 may receive a first data record, for instance, from a user. The first data record may include one or more case instances, which may pertain to processing of a case result prediction requirement associated with a case result prediction operation. A case instance may include a set of instances relevant to the case result prediction operation. The case result prediction requirement may refer to a requirement to generate a prediction for a situation and provide an explanation for the generated prediction. In an example, the situation may relate to predicting if a person may be a credit card defaulter. The case result prediction operation may refer to an entire process of generating the prediction for a situation and provide an explanation for the generated prediction. The first data record may refer to historical data that may be associated with the case result prediction requirement. Referring to credit card defaulter example above, the first data record may be a record of payments associated with the credit card holder over a period of time.

The case instances may refer to various variable features associated with the case result prediction requirement. For example, the case instances may include various reasons due to which various people may have defaulted a credit card payment. Furthermore, the case instances may refer to various different instances that may be related to the same case result prediction requirement and may include the same set of variable features. For example, for a case result prediction requirement to predict if a person may default a credit card payment, the case instances may include payment history of various people and various reasons due to which various people have been defaulting credit card payments over a period of time.

The data cluster assembler 130 may receive from the user a first data record neural network associated with the first data record and comprising one or more predictions. Each of the predictions may be associated with a case instance from multiple case instances. The first data record neural network may refer to a neural network that may be used to test the outcomes of the first data record. As mentioned above, the first data record may be a historical data set comprising the case instances associated with the case result prediction requirement. In an example, the historical dataset may be tested over a neural network to generate predictions and make alterations in the predictions so as to train the neural network for generating predictions for a data set that may be related to a similar case result prediction requirement and having the same set of features that may be used as an input in the trained neural network model. The trained neural network model may be the first data record neural network. In accordance with various embodiments of the present disclosure, a user may input the first data record and the first data record neural network to the system 110 for generating a prediction and explanation for the prediction for new data that may be related to a similar case result prediction requirement and having the same set of features that may be used as inputs in the first data record neural network. In another example, the system 110 may obtain corresponding the first data record and/or the first data record neural network from a database (not show in figures), based on a query generated by a user.

The first data record neural network may include the predictions that may be associated with a case instance. As mentioned above, the first data record neural network may be a trained neural network model that may be trained for processing the case result prediction requirement using the first data record. The first data record may include the case instances. The first data record neural network may include a prediction for a case instance from the first data record. Therefore, the first data record neural network may provide the predictions, wherein each of the predictions may be associated with a corresponding case instance. For every case instance from the first data record, there may be a corresponding prediction outcome, which may be stored in data associated with the predictions provided the first data record neural network. In accordance with various embodiments of the present disclosure, the first data record neural network may be an artificial intelligence neural network, for example, a deep neural network.

A neural network may include various types of layers, such as an input layer, an output layer, a hidden layer. A neuron, also referred to as a node, of the hidden layer may be referred to as a hidden neuron. The hidden layers and hidden neurons provide for processing input received from the input layers. The data cluster assembler 130 may implement an artificial intelligence component to determine a relative contribution of a last hidden layer to the output layer of the neural network for each case instance. The relative contribution may include determining a contribution of each hidden neuron to the output neural network. Accordingly, based on relative contributions of the hidden neurons of the last layer for a case instance a hidden neuron contribution score determined for corresponding case instance is determined. The details pertaining to relative contributions of the neurons and scoring is described later with respect to description of FIG. 4.

The data cluster assembler 130 may implement an artificial intelligence component to evaluate the hidden neuron contribution scores for assigning a similarity value to each instance for generating a plurality of instance clusters. Each of the plurality of instance clusters may be comprising the case instances that may be grouped together based on similarity features, which are represented by the hidden neuron contribution scores. The artificial intelligence component (explained in detail by way of subsequent Figs.) may include various techniques, which may be used to analyze the similarity between the case instances in the first data record.

In an example, the artificial intelligence component may deploy a clustering technique that may be used to evaluate the first data record for clustering together similar case instances from the plurality of case instances, based on the hidden neuron contribution scores. For example, to cluster the instances, the hidden neuron contribution scores are used as input features to build a K-Means clustering model, which may provide n number of clusters. A clustering model may group instances which have similar features, which in present disclosure, may be the hidden neuron contribution scores. Accordingly, the instances having similar hidden neuron contribution scores are grouped together into a cluster, which indicates clustering of instances which were predicted by the neural network using similar logic or similar learning process. In an example, to define similarity between hidden neuron contribution scores, a threshold range may be defined and the hidden neuron contribution scores in that threshold range may be considered to be similar. Additionally, while clustering, every instance may get assigned to a particular cluster and an instance may never fall into two or more different clusters.

The explanation model assembler 140 may implement a first cognitive learning operation to create a decision tree for each of the case instances in each of the instance clusters. The instance clusters generated by the data cluster assembler 130 may be used by the explanation model assembler 140 to create the decision tree for each of the case instances at a cluster level. The decision tree may be comprising a visualization of each of the plurality of predictions associated with corresponding case instance from the plurality of case instances. The first cognitive learning operation deployed by the explanation model assembler 140 for creating the decision tree may include, a decision tree generation technique.

In an example, the decision tree technique, such as a TREPAN™ decision tree method, may be used, which may draw new samples, if the minimum sample size criteria is not met at any node and learns to generalize during the training process thereby generiling better on new data. The TREPAN™ decision tree method is explained in detail by way of subsequent FIGS. It will be appreciated that other “white box” models, i.e., explainable model based decision tree generation techniques, such as CART, C5.0, and logistic regression may also be used In these models, the sample size in each node may keep on decreasing as the tree splits and grow. Further, for training all these models, TREPAN or the rest, the predicted outcome may be considered as the target variable, not the actual outcome, because the objective of the explanation model is to explain the predicted outcome and not the actual.

The explanation model assembler 140 may create the decision tree to include a plurality of root nodes and a plurality of leaf nodes, wherein each of the plurality of root nodes may be diverging to create the plurality of leaf nodes to determine a decisional pathway. The decisional pathway may be comprising the visualization of a prediction from the plurality of predictions associated with corresponding case instance from the plurality of case instances. The explanation model assembler 140 may generate a set of decision rules, by way of decision tree models, based on the plurality of root nodes and the plurality of leaf nodes.

The explanation model assembler 140 may implement the first cognitive learning operation to determine a decision tree model for each of the instance clusters. The decision tree model may be include an explanation for each prediction associated with the case instances in the instance cluster corresponding to the decision tree model. This way explanation for predictions made by the first data record neural network for each of the plurality of case instances may be determined. In an example, the explanation model assembler 140 may determine the decision tree models from the decision tree based on the decisional pathway. For example, a decision tree is a visualization of the decision tree model and a decision tree model may include justification for a prediction based on a leaf node from the plurality of leaf nodes and the associated root node from the plurality of root nodes. The decision treel model may be a set of decision rules, “if condition1 and condition2 and condition3 then outcome is X”. The decision treel model includes a root node, leaf nodes and a decision pathway from root node to leaf node—the decision rules may provide human-interpretable explanation for deep learning prediction.

The data predictor and explanator 150 may obtain a second data record, for instance, the second data record may be provided by the user. The second data record may be comprising a second data record case instance relevant to the case result prediction operation. The second data record may be a data set that may be related to the same case result prediction requirement and may have the same set of features that may be used as input in the first data record neural network. The second data record may include the second data record case instance that may be a case instance for which a user may wish to generate a prediction based on the first data record neural network and generate an explanation for the prediction generated by the first data record neural network for the second data record.

When a new data, i.e., the second data record is to be scored, prediction on the new data is done followed by the explanation for the predicted outcome. For prediction on the new data, first the trained predictive model, i.e. the deep neural network model is applied to the new data and it outputs the probability score of the event. For the explanation aspect, the hidden neuron contribution scores for the new data may be extracted. The trained cluster model may be implemented on the hidden neuron contribution scores to map the new data to one of the clusters as explained above while describing clustering process. Once the cluster mapping is known, a decision tree that was trained at that cluster, is used to generate explanation for the new data as explained in detail below.

In an example, the data predictor and explanator 150 may implement a second cognitive learning operation to map the second data record with each of the decision tree models to determine a second data index. The second data index may include a cluster mapping score assigned to each of the decision tree models based on a similarity, as indicated by hidden neuron contribution scores, between an instance cluster corresponding to the decision tree model and the second data record. For instance, a distance between a centroid of each instance cluster and a centroid of the second data record may be determined to determine a cluster mapping score for a decision tree model corresponding to the instance cluster, the cluster mapping score in being indicative of a proximity of the second data record to an instance cluster. As mentioned above, each of the case instances from the plurality of case instances may have a corresponding prediction generated by the first data record neural network and stored in form of the plurality of predictions. The data predictor and explanator 150 may map the second data record case instance with each of the plurality of decision tree models to determine the second data index. The second data index may include the cluster mapping score assigned to each of the plurality of decision tree models.

The data predictor and explanator 150 may implement a second cognitive learning operation to evaluate the cluster mapping score for each of the plurality of decision tree models to determine a decision tree model from the plurality of decision tree models with a highest cluster mapping score. For example, the cluster mapping score for a leaf node from the decisional pathway may be highest with respect to the second data record case instance. The data predictor and explanator 150 may use the decisional pathway associated with that specific leaf node and generate prediction according to the decision tree model from the plurality of decision tree models associated with the decisional pathway including that particular leaf node (explained in detail by way of subsequent Figs.).

In accordance with various embodiments of the present disclosure, the second cognitive learning operation may include a technique that may plot the second data record case instance on a graph along with the clusters. The highest cluster mapping score may be assigned to the instance cluster with shortest distance between the second data record case instance and a centroid of the instance cluster from the instance clusters. However, it will be appreciated that other mechanisms for identifying a decision tree model with a highest cluster mapping score may also be used.

The data predictor and explanator 150 may generate a second data prediction output comprising the decision tree model from the plurality of decision tree models with the highest cluster mapping score to resolve the case result prediction requirement. The second data prediction output may include a case instance prediction result based on the decision tree model from the plurality of decision tree models with the highest cluster mapping score. The case instance prediction result may be comprising a prediction result for the second data case instance. The data predictor and explanator 150 may generate an explanation for the second data prediction output based on the explanation for each of the predictions associated with the instance cluster corresponding to the decision tree model with the highest cluster mapping score.

In an example, the data predictor and explanator 150 may generate the second data prediction output based on a leaf node from the plurality of leaf nodes associated with the decisional pathway associated with the decision tree model with the highest cluster mapping score. For example, the second data record case instance may map onto a particular leaf node of the decision tree. The decision rule from the root node from the plurality of root nodes to this particular leaf node may provide the human-interpretable explanation for the second data prediction output. The set of decision rules as created by the decision tree may be used by the system 110 to generate explanation for the second data prediction output.

FIG. 2 illustrates various components of the prediction interpretation system 110, according to an example embodiment of the present disclosure. The system 110, amongst other things, may include the processor 120, the data cluster assembler 130, the explanation model assembler 140, and the data predictor and explanator 150. The processor 120 may be coupled to the data cluster assembler 130, the explanation model assembler 140, and the data predictor and explanator 150.

The data cluster assembler 130 may obtain a first data record 204. The first data record 204 may include a plurality of case instances 206 pertaining to processing a case result prediction requirement 202 associated with a case result prediction operation. The plurality of case instances 206 may be comprising a set of instances relevant to the case result prediction operation. The first data record 204 may also include the historical data that may be associated with the case result prediction requirement 202. The plurality of case instances 206 may refer to multiple features associated with the case result prediction requirement 202. The features may include reasons and information associated with the reasons for a case result prediction requirement, for instance various reasons due to which various people may have defaulted a credit card payment.

The data cluster assembler 130 may receive a first data record neural network 208 associated with the first data record 204, which may include a plurality of predictions 210. Each of the plurality of predictions 210 to be associated with a case instance from the plurality of case instances 206. The first data record neural network 208 may be a trained a neural network, which is trained based on the outcome of the first data record 204. The data record neural network 208 may be an artificial intelligence neural network, for example, a deep neural network. The historical dataset associated with the first data record 204 may be tested over a neural network to generate predictions and alterations may be made to the predictions so as to train the neural network for generating predictions for a data set that may be related to a case result prediction requirement similar to the case result prediction requirement 202 with similar set of features that may be used as inputs in the trained neural network model. The trained neural network model thus obtained may be implemented as the first data record neural network 208.

The, the first data record neural network 208 may include the plurality of predictions 210, wherein each of the plurality of predictions 210 may be associated with a case instance from the plurality of case instances 206. Therefore, for every case instance from the first data record 204, there may be a corresponding prediction outcome stored in the plurality of predictions 210 from the first data record neural network 208.

The data cluster assembler 130 may implement an artificial intelligence component 212 to may determine a hidden neuron contribution score for each hidden neuron, of each case instance. The hidden neuron contribution score may be assigned to a corresponding prediction in the first data record neural network. Owing to availability of the historical data from the first data record 204, an actual outcome for each of the case instances from the first data record may already be known. The data cluster assembler 130 may implement the artificial intelligence component 212 to map the actual outcome to each of the case instances 206 to generate predictions.

Based on the last hidden layer neuron values, the optimal weights applied to the last hidden layer by the neural network and the network predicted output, relative contributions of each hidden neuron, referred to as hidden neuron contribution 214, may be determined for each of the plurality of case instances 206. The alterations may be made the predictions made by the first data record neural network 208 for training the first data record neural network 208 with respect to the first data record 204. The alternation may be continued until the hidden neuron contribution score is equal to or greater than a threshold value.

The data cluster assembler 130 may implement the artificial intelligence component 212 to evaluate hidden neuron contribution 214 for assigning a similarity value 218 to each of the plurality of case instances 206 for generating a plurality of instance clusters 216. Each of the plurality of instance clusters 216 may include the plurality of case instances 206 that may be grouped together based on the corresponding similarity value 218. The artificial intelligence component 212 may include various natural language processing (NLP) techniques and clustering techniques, to analyze the similarity between the plurality of case instances 206 in the first data record 204.

The explanation model assembler 140 may implement a first cognitive learning operation 220 to create a decision tree 222 for each of the plurality of case instances 206 from each of the plurality of instance clusters 216. Based on the plurality of instance clusters 216 a decision tree 222 for each of the plurality of case instances 206 may be created at a cluster level. The decision tree 222 may present a visualization of each of the plurality of predictions 210 associated with corresponding case instance from the plurality of case instances 206. The explanation model assembler 140 may create the decision tree 222 to include a plurality of root nodes 224 and a plurality of leaf nodes 226, wherein each of the plurality of root nodes 224 may be diverging to create the plurality of leaf nodes 226, and the connections between the root nodes 224 and the leaf nodes may be used to determine a decisional pathway. The decisional pathway may be comprising the visualization of a prediction from the plurality of predictions 210 associated with corresponding case instance from the plurality of case instances 206. The explanation model assembler 140 may generate a set of decision rules based on the plurality of root nodes 224 and the plurality of leaf nodes 226.

The explanation model assembler 140 may implement the first cognitive learning operation 220 to determine a plurality of decision tree models 228 associated with each of the plurality of case instances 206. For each instance cluster 216, a corresponding decision tree model 228 may include an explanation for each of the plurality of predictions 210 associated with the corresponding plurality of case instances 206. In an example, the explanation model assembler 140 may determine the plurality of decision tree models 228 from the decision trees 222 based on the decisional pathway. For example, a decision tree model may include justification for a prediction based on a leaf node from the plurality of leaf nodes 226 and the associated root node from the plurality of root nodes 224.

The data predictor and explanator 150 may obtain a second data record 232. The second data record 232 may be comprising a second data record case instance 234 relevant to the case result prediction operation. The second data record 232 may a data set that may be related to the same case result prediction requirement 202 and having the same set of features that may be used as inputs in the first data record neural network 208. The second data record 232 may include the second data record case instance 234 that may be a case instance for which a user may wish to generate a prediction based on the first data record neural network 208 and generate an explanation for the prediction generated by the first data record neural network 208 for the second data record 232.

The data predictor and explanator 150 may implement a second cognitive learning operation 230 to map the second data record 232 with each of the plurality of decision tree models 228 to determine a second data index 236. As mentioned above, each of the case instances from the plurality of case instances 206 may have a corresponding prediction generated by the first data record neural network 208 and stored in form of the plurality of predictions 210. The data predictor and explanator 150 may analyze the second data record case instance 234 with respect to each of the plurality of decision tree models 228 to determine the second data index 236. The second data index 236 may include the cluster mapping score 238 assigned to each of the plurality of decision tree models 228.

The data predictor and explanator 150 may implement the second cognitive learning operation 230 to evaluate the cluster mapping score 238 for each of the plurality of decision tree models 228 to determine a decision tree model from the plurality of decision tree models 228 with the highest cluster mapping score 238. For example, use the decisional pathway associated with a leaf node with a highest cluster mapping score and generate prediction according to the decision tree model from the plurality of decision tree models 228 associated with the decisional pathway including that particular leaf node (explained in detail by way of subsequent Figs.). In an example, the second data record case instance 234 may be analyzed with respect to the cluster mapping scores of the instance clusters 216 graphically to determine a cluster instance with the highest cluster mapping score. The highest cluster mapping score may be assigned to the instance cluster with shortest distance between the second data record case instance 234 and a centroid of the instance cluster from the plurality of instance clusters 216.

Based on the highest cluster mapping score, the data predictor and explanator 150 may generate a second data prediction output comprising the corresponding decision tree model to resolve the case result prediction requirement 202. The case instance prediction result indicate a prediction result for the second data case instance, based on the decision tree model. The data predictor and explanator 150 may generate an explanation for the second data prediction output based on the explanation for each of the plurality of predictions 210 associated with the decision tree model with the highest cluster mapping score.

The data predictor and explanator 150 may generate the second data prediction output based on a leaf node from the plurality of leaf nodes 226 associated with the decisional pathway associated with the decision tree model with the highest cluster mapping score. For example, the second data record case instance 234 may map onto a particular leaf node of the decision tree 222. The decision rule from the root node from the plurality of root nodes 224 to this particular leaf node may provide the human-interpretable explanation for the second data prediction output. The set of decision rules as created by the decision tree 222 may be used by the system 110 to generate explanation for the second data prediction output. In accordance with various embodiments of the present disclosure, the data predictor and explanator 150 may create a prediction output library comprising the plurality of predictions 210 from the first data record neural network 208 and the second data prediction output. The prediction output library may be deployed for processing a subsequent case result prediction requirement 202 and for self learning of the system 110.

In an example operation, a user may provide the first data record 204 and the first data record neural network 208 into the system 110. The first data record 204 may include the plurality of case instances 206, which may be associated with the case result prediction requirement 202 of the user. The first data record neural network 208 may be trained to provide predictions for the plurality of case instances 206 from the first data record 204. The system 110 may implement the artificial intelligence component 212 to sort the plurality of case instances 206 into the plurality of instance clusters 216 based on similarity between the case instances as derived by the data cluster assembler 130. The system 110 may create the decision tree 222 for each of the plurality of case instances 206 from each of the plurality of instance clusters 216 using a decision tree generation technique, for example, a TREPAN™ technique.

In example, an explanation may be generated in the form of the plurality of decision tree models 228 for each of the plurality of predictions 210 associated with the corresponding case instance from the plurality of case instances 206 using the first cognitive learning operation 220. The artificial intelligence component 212, the first cognitive learning operation 220, the second cognitive learning operation 230 may include deployment of a cluster-TREPAN™ technique. The cluster-TREPAN™ technique may provide the hidden neuron contribution score 214 to the first data record 204. The cluster-TREPAN™ technique may be deployed to create the decision tree 222 for visualization of a prediction from the plurality of predictions 210 for a case instance from the plurality of case instances 206 at a cluster level. The cluster-TREPAN™ algorithm may be deployed to generate the plurality of decision tree models 228. Each of the plurality of decision tree models 228 may represent an explanation for a prediction from the plurality of predictions 210. Therefore, the cluster-TREPAN™ algorithm may generate an explanation for each of the plurality of predictions 210. The system 110 may store the plurality of decision tree models 228. The user may input the second data record 232 comprising the second data record case instance 234 relevant to the case result prediction operation to the system 110. The cluster-TREPAN™ technique may map the second data record case instance 234 with the plurality of decision tree models 228. The system 110 may create the second data index 236 comprising the cluster mapping score 238 for each of the plurality of decision tree models 228 with regards to the second data record case instance 234.

The system 110 may generate the second data prediction output comprising a prediction for the second data record case instance 234 based on the decision tree model from the plurality of decision tree models 228 that may have been assigned at the highest cluster mapping score. The second data prediction output may further include the justification for the prediction corresponding to the decision tree model from the plurality of decision tree models 228 that may have been assigned at the highest cluster mapping score. Additionally, the system 110 may use the previously fed first data record neural network 208 to get the prediction for the second data record case instance 234 and then use the saved decision tree model from the plurality of decision tree models 228 to get the corresponding explanation for the predicted outcome for the second data record case instance 234.

The system 110 described herein presents a system for that may combine clustering of the similar relationships learned by a neural network with application of a decision tree method at a cluster level to extract a set of reason codes or decision rules for explaining a neural network prediction outcome at an instance level. Owing to clustering performed by the system 110, improved reason codes may be generated, which may provide concise human interpretable explanations for the model outcome at an individual instance level. Further, the reason codes may be intuitive and logical. Furthermore, the system 110 may require minimum or no human intervention for drawing an explanation for generating a prediction. The system 110 may include various natural language generation (NLG) techniques to convert reason codes in form of conditions to statements in natural language.

The system 110 may be flexible and scalable thereby making it suitable for various major industries and for a wide range of use cases such as loan default prediction, credit card payment default prediction, churn prediction, machine failure prediction, production recommendation, fraud detection, sales forecasting, disease detection and so on.

In accordance with various embodiments of the present disclosure, the system 110 may serve as a workbench for training the first data record neural network 208 to generate the explanation model in form of the plurality of decision tree models 228 using a machine learning algorithm such as the cluster-TREPAN™ technique. The system 110 may also provide the services for generating prediction on second data record case instance 234 using the first data record neural network 208 and generating the corresponding explanation for the predicted outcome using the plurality of decision tree models 228 developed through the system 110.

In accordance with various embodiments of the present disclosure, the cluster-TREPAN™ technique used herein may be in python language which may be reused for training explanation model/decision tree models for a new predictive modeling problem. The cluster-TREPAN™ technique may be a machine learning technique that may be implemented as part of the artificial intelligence component 212, the first cognitive learning operation 220, the second cognitive learning operation 230.

FIG. 3 illustrates a flow diagram of a prediction interpretation system 300, for generating an explanation for a predicted outcome of a new instance according to an example embodiment of the present disclosure. All components of the system 110 described way of FIG. 1 and FIG. 2 may be used by the prediction interpretation system 300 and the system 300 may be interchangeably referred to as the system 110. For the sake of brevity and technical clarity, the components of the system 110 may not be described for the prediction interpretation system 300. The prediction interpretation system 300 may include a historical dataset 302 and a neural network 314. In an example, the historical dataset 302 may be the first data record 204 and the neural network 314 may be the first data record neural network 208 associated with the first data record 204. The neural network 314 may be used to generate an explanation model 304. The explanation model 304 may be the plurality of decision tree models 228 as described by way of FIG. 1 and FIG. 2. The explanation model 304 may be saved as a saved explanation model 306. The prediction interpretation system 300 may receive new data 316 from user of the prediction interpretation system 300. The system may input the new data 316 to the neural network 314. The neural network 314 may generate a prediction 312. for the new data 316 generated through the neural network 314. The prediction interpretation system 300 may further include a retrieval 308, which may include using the saved explanation model 306 on the prediction 312 to generate explanation 310. The prediction 312 and explanation 310 may be the second data prediction output as described above.

FIG. 4 illustrates a flow diagram 400 depicting a hybrid approach for training a neural network deployed by a prediction interpretation system, according to an example embodiment of the present disclosure. All components of the system 110, and the prediction interpretation system 300 described way of FIG. 1, FIG. 2 and FIG. 3 may be deployed for the flow diagram 400. For the sake of brevity and technical clarity the components described above may not be described for the flow diagram 400. The flow diagram 400 describes the deployment of the cluster-TREPAN™ technique that may combine clustering of the similar relationships between the plurality of case instances 206 learned by a neural network with application of a TREPAN™ decision tree method at a cluster level to extract a set of reason codes or decision rules for explaining a neural network prediction outcome at an instance level for the second data record case instance 234. The flow diagram 400 describes the clustering part of the cluster-TREPAN™ technique. The flow diagram 400 initiates at a start block 402, which may refer to initiation of the cluster-TREPAN™ technique. In an example, initial weights may be randomly assigned and then through several epochs, the network may adjust and optimize the weights by minimizing a loss function using a technique, such as Gradient Descent.

After initiation, optimized weights from the last hidden layer to the output layer of the trained network, for a case instance may be obtained. Further, a relative contribution of the last layer of a hidden neural network to the output of the network for each case instance may be calculated. The flow diagram 400 may further include a clustering at block 408. The clustering 408 may include clustering the plurality of case instances 206 based on the relative contribution of each case instance as calculated at block 406. In an example, the clustering 408 may be done by building a k-means model for clustering instances based on relative contribution of each case instance. At block 408, the decision tree 222 may be built for each of the case instances as mentioned above using a technique such as the TREPAN™. The flow diagram 400 terminates at block 412.

In accordance with various embodiments of the present disclosure, the computation at blocks 406 and 408 may include the deployment of various criteria to partition the first data record 204 into similar data points. The criteria may be based on the factor space, which may be the last hidden layer of a neural network. For each instance, k, the relative contribution, I_{k,j} of the hidden neural network neuron “j” to the output of the neural network may be calculated as:

$${I}_{k , j} = \frac{{w}_{j} ( {z}_{j}^{k} - {\overline{z}}_{j} )}{{Σ}_{j} \vert {w}_{j} ( {z}_{j}^{k} - {\overline{z}}_{j} ) \vert} j = 1 , 2 , … , n \qquad ( 1 )$$

wherein, the wⱼ may be the weight between the hidden neural network neuron “j” to the output neuron, zⱼₖ may be the output of the hidden neural network neuron “j” for the instance k, and z̅ⱼ may be the mean value of zⱼ of outputs of the hidden neuron for each of the case instances (k). The I_{k,j} may be treated as features of the plurality of case instances 206. The number of I_{k,j} for each instance “k” may be equal to the number of hidden neural network neurons “n” in the last hidden layer of the neural network. The neural network neurons may various features required for generating the plurality of predictions 210. The I_{k,j} may be used for clustering using the K-Means clustering technique.

For example, for a case result prediction requirement 202, which includes a credit card default prediction problem, the trained Feed Forward Neural Network (FFNN) model may have 38 input neurons (features), 4 hidden layers with 128 neurons in each of the first two hidden layers and 64 neurons in each of the third and the last hidden layer and one output neuron in the output layer. The FFNN model may be trained using a rectified linear unit (RELU) activation function in the hidden layers and a sigmoid activation function in the output layer. In an example, from the last hidden layer of the above trained network which had 64 neurons, the system 110 may extract 64 output values of the sigmoid neurons for each instance and use them to derive 64 I_{k,j} variables, which may be relative contribution of hidden neuron “j” to the predicted output for instance k”, using the equation mentioned above. The I_{k,j} may be treated as features of the plurality of case instances 206 and use them for clustering the instances by applying the K-Means clustering technique. The intuition may be that similar pattern of information flow in the prediction process of the network will be captured by similar I_{k,j}, thus the instances predicted on similar reasoning will get grouped together in the same cluster.

FIG. 5 illustrates a flow diagram 500 for the training explanation model and generating decision rules that may provide a human-interpretable explanation for a prediction using the prediction interpretation system 110, according to an example embodiment of the present disclosure. All components of the system 110, and the prediction interpretation system 300 described way of FIG. 1, FIG. 2, FIG. 3 and FIG. 4 may be deployed for the flow diagram 500. For the sake of brevity and technical clarity, the components described above may not be described for the flow diagram 500. The flow diagram 500 may include a trained neural network model 502. The flow diagram 500 may further include a hidden layer representation of trained neural network 504. The system 110 may generate the hidden layer representation of trained neural network 504. The flow diagram 500 may further include a K-means clustering 506 (as described above). In an example, the system 110 may generate the K-means clustering 506 after generating the hidden layer representation of trained neural network 504. The flow diagram 500 may further include a decision tree 508. The decision tree 508 may be the decision tree 222 created by the system 110. The decision tree 508 may include decision rules from the decision tree 222 and may provide human interpretable explanation for deep learning prediction.

In an example, the system 110 may implement the decision tree 222, generated using TREPAN™ technique, which may be in the python language in PyCharm™. The TREPAN™ technique may take the trained neural network model 502 and a set of training data such as the first data record 204 as inputs. It may produce the decision tree 222 that may provide a close approximation to the function represented by the given trained network. The TREPAN™ technique may draw new samples from the first data record 204 while growing the tree based on minimum sample criteria at each node and may use the trained neural network model 502 to assign a class label for the new samples. In an example, once the K-Means clustering using relative contribution of hidden neurons (as described above) in the last hidden layer to the output of the network may be done and a number of clusters may be generated. The TREPAN™ technique may, at each cluster level approximate the decision logic used by the FFNN model. The system 110 may examine all the decision trees 222 generated by the TREPAN™ technique for ensuring that they are coherent in terms of decision logic and threshold values.

FIG. 6 illustrates a flow diagram 600 for generating prediction explanation using the prediction interpretation system 110, according to an example embodiment of the present disclosure. All components of the system 110, and the prediction interpretation system 300 described way of FIG. 1, FIG. 2, FIG. 3, FIG. 4 and FIG. 5 may be deployed for the flow diagram 600. For the sake of brevity and technical clarity, the components described above may not be described for the flow diagram 600. In an example, the flow diagram 600 may represent an entire view of the “Cluster-TREPAN” methodology described by way of the system 110, from training the explanation model to using it to generate explanation for a predicted outcome of an instance.

The flow diagram 600-1 may initiate at a start block 602, which may represent initiation of the Cluster-TREPAN™ algorithm. At block 604, a trained neural network 604 may be obtained. At block 606, a neural network last hidden layer weight is read. At bock 608, a relative contribution of the last layer hidden neural network neurons to the plurality of predictions 210 (described above) may be determined. At block 610, a K-means clustering model is built using the relative contribution. At block 612, the decision tree 222 may be built or generated using a decision tree building technique, such as the TREPAN™ technique for each of the plurality of instance clusters 216. Furthermore, an explanation model may be generated for each of the plurality of predictions 210. The flow diagram 600 terminates end block 614 that may represent completion of generation of the plurality of instance clusters 216 and the decision tree 222.

The flow diagram 600-2 may initiate at a start block 616, which may represent receiving the second data record 232 by the system 110. At block 620, an outcome for the second data record case instance 234 may be predicted using the first data record neural network 208. At block 622, using trained the K-means cluster centroids derived at the block 610, the second data record case instance 234 is mapped to an appropriate cluster. At block 624, the decision tree model 222 of the appropriate cluster identified at block 622 is obtained for the second data record case instance 234. At block 626 an explanation for the prediction 620 may be generated using the decision tree model 222 identified at block 624. The bock 626 may be followed by an end block 628 that may represent generation of the second data prediction output.

In an example operation, a user may select the pre-trained neural network model 604. As the user may select on a “GET PREDICTION” function, the system 110 may run the pre-trained neural network model 604 on the new data instance to score the new data instance and give the predicted outcome with a predicted probability. The user then selects an explanation model, such as “Cluster-TREPAN” explanation model that may have been previously trained and saved in the platform and the user may click on a “GET EXPLANATION”. Function. The saved “Cluster-TREPAN” explanation model has two components. A first component may be trained K-Means clusters and a second component may be a trained TREPAN™ Decision tree 222 for each cluster. The system 110 may first use the previously trained and saved clustering model to map the new data instance to the right cluster. The system 110 may measure the distance of the new data instance from each cluster centroid and selects the cluster for which the distance is shortest. Next, the system 110 may select the trained TREPAN™ Decision tree 222 of the identified cluster to which the new data instance may be mapped and the system 110 may run the selected TREPAN™ decision tree 222 models on the new data instance. The outcome may be that the new data instance may fall into a particular leaf node of this TREPAN™ Decision tree 222. The decision rule from the root node to this particular leaf node provides the human-interpretable explanation for this new data instance. The new data instance may be the second data record case instance 234.

The steps 602, 604, 606, 608, 610, 612, and the 614 of the flow diagram 600 may depict the Cluster-TREPAN™ explanation model training process. The steps 616, 618,620, 622, 624, 626, and 628 of the flow diagram 600 may depict how the trained Cluster-TREPAN™ explanation model may be used to generate an explanation for a predicted outcome of a case instance. Although the present disclosure is explained with reference to TREPAN™ technique, it may be appreciated that other similar techniques may also be used.

FIG. 7 illustrates a flow diagram 700 for implementing the system 110, according to an example embodiment of the present disclosure. All components of the system 110, and the prediction interpretation system 300 described way of FIG. 1, FIG. 2, FIG. 3, FIG. 4, FIG. 5 and FIG. 6 may be deployed for the flow diagram 700. For the sake of brevity and technical clarity, the components described above may not be described for the flow diagram 700. The flow diagram 700 might include a start block 702 that may represent initiation of the Cluster-TREPAN™ algorithm. The flow diagram 700 illustrates functioning of the Cluster-TREPAN™ algorithm. At block 704, the system 110 may create a root node for the decision tree 222 using the first data record 204. At block 704 a maximum depth and minimum number of samples the Cluster-TREPAN™ algorithm might analyze from the first data record 204 may be set. In an example, a trained neural network is set using Oracle™ platform. At block 706 706, the Cluster-TREPAN™ algorithm may score the first data record 204 with respect to predictions made for the plurality of case instances 206 by the Oracle™ neural network.

At block 708 determine all possible split points for all possible features from the first data record 204. In an example, entropy may be used to determine the best split. At block 710, the first data record 204 may be split into various clusters and the plurality of instance clusters 216 may be identified. At block 712 it may be determined if the maximum depth set at the block 704 may be achieved by the block 710. If the maximum depth set at the block 704 may be achieved by the block 710, the system 110 may create a decision trees 720. However, if the maximum depth set at the block 704 may not be achieved at the block 710, the system 110 may proceed to block 714.

At block 714 it may be ascertained if the instance cluster from the plurality of instance clusters 216 that may not have achieved the maximum depth set at the block 704 are homogenous. If the instance cluster from the plurality of instance clusters 216 that may not have achieved the maximum depth set at the block 704 may be homogenous, the system 110 may create the decision trees 720. However, if the instance cluster from the plurality of instance clusters 216 that may not have achieved the maximum depth set at the block 704 may not be homogenous, then the system 110, the flowchart 700 may proceed to block 716. At block 716 it may be ascertained if a sample size for the instance cluster from the plurality of instance clusters 216 may not be homogenous to be less than the minimum number of required samples that were set at the block 704. If the sample size may be less than the minimum number of required samples that was set at the block 704, then the system 110 may proceed to block 724, wherein the system 110 may draw new samples from the first data record 204 to meet the minimum number of required samples that was set at the creation 704. The block 724 may include block 718, wherein the drawn samples may be appended to a leaf node of the decision trees 720.

Additionally, at block 726, the system 110 may check distribution of the plurality of root nodes 224 and the plurality of leaf nodes 226. If the distribution of the plurality of root nodes 224 and the plurality of leaf nodes 226 may be same, then the system 110 may deploy the distribution of the plurality of root nodes 224 for drawing new samples at the block 724. If the distribution of the plurality of root nodes 224 and the plurality of leaf nodes 226 may be different, then the system 110 may deploy the distribution of the plurality of leaf nodes 226 for drawing new samples at the block 724. If the sample size may not be less than the minimum number of required samples that were set at the block 704, then the system 110 may branch to the block 708. The process of drawing new samples at the block 724 or executing the calculations performed at the block 708 may continue until entire first data record 204 may be processed into the decision trees 720. The system 110 may execute a display 722 for displaying the decision trees 720 to a user of the system 110. The flow diagram 700 may further include an end block 728, wherein the system 110 may exit the process depicted by flow diagram 700 after executing the display 722.

FIG. 8 illustrates a pictorial representation 800 of a decision tree 222 created by the system 110, according to an example embodiment of the present disclosure. All components of the system 110, and the prediction interpretation system 110 described way of FIG. 1, FIG. 2, FIG. 3, FIG. 4, FIG. 5, FIG. 6 and FIG. 7 may be deployed for the pictorial representation 800. For the sake of brevity and technical clarity, the components described above may not be described for the pictorial representation 800. The pictorial representation 800 may illustrate the plurality of root nodes 224 and the plurality of leaf nodes 226 for the decision tree 222 in accordance with an exemplary embodiment of the present disclosure. The pictorial representation 800 may include a decision tree 802. The decision tree 802 may be an example of a trained Cluster-TREPAN™ algorithm-based decision tree 222. The pictorial representation 800 may illustrate the TREPAN™ result for an exemplary cluster #9. The cluster #9 may be an instance cluster from the plurality of instance clusters 216. The pictorial representation 800 may comprehend and analyze the decision path for a Node 16. At a root node named “node 0”, the decision trees 802 splits by a feature, ‘pd_a6’. The ‘pd_a6’ feature may refer to a number of times a person may have been late in making the credit card payment in past 6 months. If pd_a6<=1 is F (false)=>pd_a6>1, it might mean that if the person may have been late in making the credit card payment in past 6 months and if ratio_pd_l3_f3<=1.25 is F (false)=>ratio_pd_l3_f3>1.25, it might mean that the person may have been late in making the credit card payment 1.25 times more in last 3 months than in the first 3 months, then “1”=>Default” (Node 16). Both the above conditions may intuitively favor defaulting behavior and hence the TREPAN™ decision logic makes sense.

Similarly, the decision paths of the other leaf nodes, Node 2, 6, 7, 8, 9, 13, 14 and 15 may be comprehended. Additionally, the value of the ‘ratio_pd_l3_f3’ greater than 1 may imply that the pd_l3, frequency of the person being late in making the credit card payment in last 3 months is greater than pd_f3, frequency of the person being late in making the credit card payment in first 3 months which in turn means the person may be exhibiting a defaulting behavior and the behavior may have been deteriorating overtime. The “default” decision in “Node 15” and “Node 16” may thus be explained. The decision trees 802 may illustrate a second feature, “2pd_count”, which may mean number of times a person was two months overdue on making credit card payment. The decision trees 802 may illustrate that if “2pd_count” may be greater than a threshold determined by the tree, it may lead to a “Default” decision as illustrated by a “Node 14”. This may be logical as a positive correlation between the “number of times a person may be overdue on payment for two months” and “default” intuitively may generate the human interpretable explanation for neural network prediction. Additionally, for a limit balance feature, the decision trees 802 may illustrate if the limit_bal may be above the threshold mentioned above, it may lead to a “Non-Default” decision as illustrated by a “Node 9”. This may be correct as there might be a negative correlation between limit balance and default from the cluster profiling and also from a logistic regression model that the system 110 might create for analyzing the decision trees 802.

One of ordinary skill in the art will appreciate that while the present disclosure describes the use of TREPAN™ decision tree technique for explaining the neural network prediction outcome at an instance level, other techniques for building interpretable models which do not have the challenge with decreasing sample size as in C&RT or C5.0 may be used without departing from the scope of the disclosure. These techniques may include, for example, Logistic Regression, Multiple Regression.

FIG. 9 illustrates a hardware platform 900 for implementation of the system 900, according to an example embodiment of the present disclosure. Particularly, computing machines such as but not limited to internal/external server clusters, quantum computers, desktops, laptops, smartphones, tablets and wearables which may be used to execute the system 900 or may have the structure of the hardware platform 900. The hardware platform 900 may include additional components not shown and that some of the components described may be removed and/or modified. In another example, a computer system with multiple GPUs can sit on external-cloud platforms including Amazon Web Services, or internal corporate cloud computing clusters, or organizational computing resources, etc.

Over FIG. 9, the hardware platform 900 may be a computer system 900 that may be used with the examples described herein. The computer system 900 may represent a computational platform that includes components that may be in a server or another computer system. The computer system 900 may execute, by a processor (e.g., a single or multiple processors) or other hardware processing circuit, the methods, functions and other processes described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system 900 may include a processor 905 that executes software instructions or code stored on a non-transitory computer-readable storage medium 910 to perform methods of the present disclosure. The software code includes, for example, instructions to gather data and documents and analyze documents. In an example, the data cluster assembler 130, the explanation model assembler 140, and the data predictor and explanator 150 may be software codes or components performing these steps.

The instructions on the computer-readable storage medium 910 are read and stored the instructions in storage 915 or in random access memory (RAM) 920. The storage 915 provides a large space for keeping static data where at least some instructions could be stored for later execution. The stored instructions may be further compiled to generate other representations of the instructions and dynamically stored in the RAM 920. The processor 905 reads instructions from the RAM 920 and performs actions as instructed.

The computer system 900 further includes an output device 925 to provide at least some of the results of the execution as output including, but not limited to, visual information to users, such as external agents. The output device can include a display on computing devices and virtual reality glasses. For example, the display can be a mobile phone screen or a laptop screen. GUIs and/or text are presented as an output on the display screen. The computer system 900 further includes input device 930 to provide a user or another device with mechanisms for entering data and/or otherwise interact with the computer system 900. The input device may include, for example, a keyboard, a keypad, a mouse, or a touchscreen. Each of these output devices 925 and input devices 930 could be joined by one or more additional peripherals.

A network communicator 935 may be provided to connect the computer system 900 to a network and in turn to other devices connected to the network including other clients, servers, data stores, and interfaces, for instance. A network communicator 935 may include, for example, a network adapter such as a LAN adapter or a wireless adapter. The computer system 900 includes a data source interface 940 to access data source 945. A data source is an information resource. As an example, a database of exceptions and rules may be a data source. Moreover, knowledge repositories and curated data may be other examples of data sources.

FIGS. 10A and 10B illustrate a process flowchart for the generation of prediction explanation using a prediction interpretation system, according to an example embodiment of the present disclosure.

It should be understood that method steps are shown here for reference only and other combinations of the steps may be possible. Further, the method 1000 may contain some steps in addition to the steps shown in FIG. 10. For the sake of brevity, construction and operational features of the system 110 which are explained in detail in the description of FIGS. 1-9 are not explained in detail in the description of FIGS. 10A and 10B. The method 1000 may be performed by a component of the system 110, such as the processor 120, the data cluster assembler 130, the explanation model assembler 140, and the data predictor and explanator 150.

At block 1002, a first data record, such as the first data record 204 may be received. The first data record may be comprising multiple case instances, such as the case instances 206 associated with a case result prediction operation. The plurality of case instances 206 may be comprising a set of instances relevant to the case result prediction operation.

At block 1004, a first data record neural network, such as the first data record neural network 208 associated with the first data record 204 may be obtained. The first data record neural network may include multiple predictions, such as the plurality of predictions 210. Each of the plurality of predictions 210 may be associated with a case instance from the plurality of case instances 206.

At block 1006, an artificial intelligence component, such as the artificial intelligence component 212 may be implemented to determine a hidden neuron contribution score for each of the plurality of case instances, based on a contribution of each neuron in a last hidden layer to an output layer of the first data record neural network. In an example, determining the hidden neuron contribution score may include determining, for each hidden neuron, a weight assigned to the last hidden layer corresponding to the case instance; determining an output of each hidden neuron for the case instance; computing a mean value of the output for each hidden neuron; and determining the hidden neuron contribution score for the case instance based on the weight, the output, the mean value of the output, for each hidden neuron in the last hidden layer for the case instance.

At block 1008, the artificial intelligence component 212 may be implemented to assign a similarity value to each of the plurality of case instances, based on the hidden neuron contribution score of each of the plurality case instance.

At block 1010, a plurality of instance clusters may be generated, based on the similarity value, each of the plurality of instance clusters comprising one or more case instances clustered together based on the similarity value. For example, to generate the plurality of clusters a clustering model, such as K-means clustering model, is built based on the hidden neuron contribution scores to provide the plurality of clusters, the clustering model to group instances having similar hidden neuron contribution scores together.

At block 1012, the first cognitive learning operation 220 may be implemented to create a decision tree 222 for each of the plurality of case instances 206 from each of the plurality of instance clusters 216. The decision tree 222 may be indicative of each of the plurality of predictions 210 associated with corresponding case instance from the plurality of case instances 206.

At block 1014, the first cognitive learning operation 220 may be implemented to determine a plurality of decision tree models 228 for each of the decision trees 222 associated with each of the plurality of case instances 206. Each of the plurality of decision tree models 228 may be comprising a justification for each of the plurality of predictions 210 associated with the corresponding plurality of case instances 206 from each of the plurality of instance clusters 216.

At block 1016, a second data record, such as the second data record 232 may be received. The second data record 232 may include a second data record case instance 234 relevant to the case result prediction operation.

At block 1018, a second cognitive learning operation, such as the second cognitive learning operation 230 may be implemented to analyze the second data record with respect to each of the plurality of decision tree models to determine a second data index, the second data index comprising a cluster mapping score assigned to each of the plurality of decision tree models based on a similarity between the instance cluster corresponding to the decision tree model and the second data record. For example, the first record neural network, i.e., the trained deep neural network model is applied to the second data record to determine determine a corresponding hidden neuron contribution score. Further, a trained cluster model may be implemented on the hidden neuron contribution scores to map the the second data record to one of the clusters.

At block 1020, the second cognitive learning operation 230 may be implemented to evaluate the cluster mapping score 238 for each of the plurality of decision tree models 228 to determine a decision tree model from the plurality of decision tree models 228 with a highest cluster mapping score.

At block 1022, a second data prediction output may be generated comprising the decision tree model with the highest cluster mapping score for providing an explanation for a prediction provided in the second data prediction output. Thus, once the cluster mapping is known, a decision tree that was trained at that cluster, is used to generate explanation for the second data record.

In an example, the method 1000 may further include implementing the first cognitive learning operation 220 to create the decision tree 222 to include a plurality of root nodes 224, and a plurality of leaf nodes 226. Each of the plurality of root nodes 224 may be diverging to create the plurality of leaf nodes 226 to determine a decisional pathway comprising the visualization of a prediction from the plurality of predictions 210. In an example, the first cognitive learning operation 220 may be implemented to determine the plurality of decision tree models 228 from the decision tree 222 based on the decisional pathway.

In an example, the method 1000 may further comprise generating the second data prediction output to include a case instance prediction result based on the decision tree model from the plurality of decision tree models 228 with the highest cluster mapping score. The case instance prediction result comprising a prediction result for the second data case instance.

In an example, the method 1000 may further include generating an explanation for the second data prediction output based on the explanation for each of the plurality of predictions 210 associated with the decision tree model from the plurality of decision tree models 228 with the highest cluster mapping score. In an example, the method 1000 may further include generating the second data prediction output based on a leaf node from the plurality of leaf nodes 226 associated with the decisional pathway associated with the decision tree model from the plurality of decision tree models 228 with the highest cluster mapping score.

In an example, the method 1000 may further comprise creating a prediction output library comprising the plurality of predictions 210 from the first data record neural network 208 and the second data prediction output, the prediction output library to be deployed for processing a subsequent case result prediction requirement 202

In an example, the method 1000 may be practiced using a non-transitory computer-readable medium. In an example, the method 1000 may be a computer-implemented method.

The present disclosure provides for a prediction explanation system that may generate a comprehensible human-interpretable explanation for a deep neural network prediction. Furthermore, the present disclosure may categorically implement a hybrid approach for explaining predictions of a deep neural network model, that may combine clustering of the hidden layer representation by grouping similar relationships learned by a trained neural network and amalgamate the same with application of the decision tree method at a cluster level to extract a set of reason codes or decision rules for explaining the neural network prediction outcome at an instance level. This may enable generation of human interpretable explanations for deep neural network model outcome at an individual instance level. Unlike most other approaches that treat the network as the “black-box” and aim to find trends and patterns to map inputs to the network predicted output, the system 110 may be able to capture and explain the flow of information within the “black box” deep neural network.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

I/We claim:

1. A system comprising:
a processor;
a data cluster assembler coupled to the processor, the data cluster assembler to:
obtain a first data record comprising a plurality of case instances, the plurality of case instances comprising a set of instances relevant to a case result prediction operation;
obtain a first data record neural network trained based on the first data record, the first data record neural network to provide a plurality of predictions, each of the plurality of predictions to be associated with a case instance from the plurality of case instances; and
implement an artificial intelligence component to:
determine a hidden neuron contribution score for each of the plurality of case instances, based on a contribution of each neuron in a last hidden layer to an output layer of the first data record neural network;
assign a similarity value to each of the plurality of case instances, based on the hidden neuron contribution score of each of the plurality case instance; and
generate a plurality of instance clusters, based on the similarity value, each of the plurality of instance clusters comprising one or more case instances clustered together based on the similarity value;
an explanation model assembler coupled to the processor, the explanation model assembler to implement a first cognitive learning operation to determine for each instance cluster a decision tree model, the decision tree model for an instance cluster comprising an explanation for each of the plurality of predictions associated with a corresponding case instance in the instance cluster; and
a data predictor and explanator coupled to the processor, the data predictor and explanator to:
obtain a second data record comprising a second data record case instance relevant to the case result prediction operation;
implement a second cognitive learning operation to:
analyze the second data record with respect to each of the plurality of decision tree models to determine a second data index, the second data index comprising a cluster mapping score assigned to each of the plurality of decision tree models based on a similarity between the instance cluster corresponding to the decision tree model and the second data record; and
identify the decision tree model with a highest cluster mapping score from the plurality of decision tree models; and
generate a second data prediction output comprising the identified decision tree model for providing an explanation for a prediction provided in the second data prediction output.

2. The system as claimed in claim 1, wherein the explanation model assembler is to create a decision tree for each of the plurality of instance clusters, the decision tree including a visualization of each of the plurality of predictions associated with the corresponding case instance in the instance cluster.

3. The system as claimed in claim 1, wherein the explanation model assembler is to generate a set of decision rules, based on a plurality of root nodes and a plurality of leaf nodes of the decision tree, the decision tree model comprising the set of decision rules.

4. The system as claimed in claim 1, wherein the data predictor and explanator creates a prediction output library comprising the plurality of predictions from the first data record neural network and the second data prediction output, the prediction output library to be deployed for processing a subsequent case result prediction requirement.

5. The system as claimed in claim 1, wherein the data cluster assembler is to determine the hidden neuron contribution score for a case instance:
determine, for each hidden neuron, a weight assigned to the last hidden layer corresponding to the case instance;
determine an output of each hidden neuron for the case instance;
compute a mean value of the output for each hidden neuron; and
determine the hidden neuron contribution score for the case instance based on the weight, the output, the mean value of the output, for each hidden neuron in the last hidden layer for the case instance.

6. The system as claimed in claim 1, wherein to analyze the second data record the data predictor and explanator is to apply the first data record neural network to the second data record to determine a corresponding hidden neuron contribution score.

7. The system as claimed in claim 1, wherein to generate the plurality of clusters the data cluster assembler is to build a clustering model based on hidden neuron contribution scores to provide the plurality of clusters, wherein the clustering model is to group instances having similar hidden neuron contribution scores together.

8. A method comprising:
obtaining, by a processor, a first data record comprising a plurality of case instances, the plurality of case instances comprising a set of instances relevant to a case result prediction operation;
obtaining, by the processor a first data record neural network trained based on the first data record, the first data record neural network to provide a plurality of predictions, each of the plurality of predictions to be associated with a case instance from the plurality of case instances;
implementing, by the processor, an artificial intelligence component to:
determine a hidden neuron contribution score for each of the plurality of case instances, based on a contribution of each neuron in a last hidden layer to an output layer of the first data record neural network;
assign a similarity value to each of the plurality of case instances, based on the hidden neuron contribution score of each of the plurality case instance; and
generate a plurality of instance clusters, based on the similarity value, each of the plurality of instance clusters comprising one or more case instances clustered together based on the similarity value;
implementing, by the processor, a first cognitive learning operation to determine for each instance cluster a decision tree model, the decision tree model for an instance cluster comprising an explanation for each of the plurality of predictions associated with a corresponding case instance in the instance cluster;
obtaining, by the processor, a second data record comprising a second data record case instance relevant to the case result prediction operation; and
implementing, by the processor, a second cognitive learning operation to:
analyze the second data record with respect to each of the plurality of decision tree models to determine a second data index, the second data index comprising a cluster mapping score assigned to each of the plurality of decision tree models based on a similarity between the instance cluster corresponding to the decision tree model and the second data record; and
identify the decision tree model with a highest cluster mapping score from the plurality of decision tree models; and
generating, by the processor, a second data prediction output comprising the identified decision tree model for providing an explanation for a prediction provided in the second data prediction output.

9. The method as claimed in claim 8, wherein the method further comprises creating a decision tree for each of the plurality of instance clusters, the decision tree including a visualization of each of the plurality of predictions associated with the corresponding case instance in the instance cluster

10. The method as claimed in claim 8, wherein the method further comprises generating a set of decision rules, based on a plurality of root nodes and a plurality of leaf nodes of a decision tree corresponding to the decision tree model, the decision tree model comprising the set of decision rules.

11. The method as claimed in claim 8, wherein the method further comprises creating a prediction output library comprising the plurality of predictions from the first data record neural network and the second data prediction output, the prediction output library to be deployed for processing a subsequent case result prediction requirement.

12. The method as claimed in claim 8, wherein determining the hidden neuron contribution score for a case instance comprises:
determining, for each hidden neuron, a weight assigned to the last hidden layer corresponding to the case instance;
determining an output of each hidden neuron for the case instance;
computing a mean value of the output for each hidden neuron; and
determining the hidden neuron contribution score for the case instance based on the weight, the output, the mean value of the output, for each hidden neuron in the last hidden layer for the case instance.

13. The method as claimed in claim 8, wherein analyzing the second data record comprises applying the first data record neural network to the second data record to determine a corresponding hidden neuron contribution score.

14. The method as claimed in claim 8, wherein generating the plurality of clusters comprises building a clustering model based on hidden neuron contribution scores to provide the plurality of clusters, wherein the clustering model is to group instances having similar hidden neuron contribution scores together.

15. A non-transitory computer readable medium comprising machine executable instructions that are executable by a processor to:
obtain a first data record comprising a plurality of case instances, the plurality of case instances comprising a set of instances relevant to a case result prediction operation;
obtain a first data record neural network trained based on the first data record, the first data record neural network to provide a plurality of predictions, each of the plurality of predictions to be associated with a case instance from the plurality of case instances;
implement an artificial intelligence component to:
determine a hidden neuron contribution score for each of the plurality of case instances, based on a contribution of each neuron in a last hidden layer to an output layer of the first data record neural network;
assign a similarity value to each of the plurality of case instances, based on the hidden neuron contribution score of each of the plurality case instance; and
generate a plurality of instance clusters, based on the similarity value, each of the plurality of instance clusters comprising one or more case instances clustered together based on the similarity value;
implement a first cognitive learning operation to determine for each instance cluster a decision tree model, the decision tree model for an instance cluster comprising an explanation for each of the plurality of predictions associated with a corresponding case instance in the instance cluster;
obtain a second data record comprising a second data record case instance relevant to the case result prediction operation; and
implement a second cognitive learning operation to:
analyze the second data record with respect to each of the plurality of decision tree models to determine a second data index, the second data index comprising a cluster mapping score assigned to each of the plurality of decision tree models based on a similarity between the instance cluster corresponding to the decision tree model and the second data record; and
identify the decision tree model with a highest cluster mapping score from the plurality of decision tree models; and
generate a second data prediction output comprising the identified decision tree model for providing an explanation for a prediction provided in the second data prediction output.

16. The non-transitory computer readable medium as claimed in claim 15 including machine executable instructions that are executable by the processor to further generate a set of decision rules, based on a plurality of root nodes and a plurality of leaf nodes of a decision tree corresponding to the decision tree model, the decision tree model comprising the set of decision rules.

17. The non-transitory computer readable medium as claimed in claim 15 including machine executable instructions that are executable by the processor to create a prediction output library comprising the plurality of predictions from the first data record neural network and the second data prediction output, the prediction output library to be deployed for processing a subsequent case result prediction requirement.

18. The non-transitory computer readable medium as claimed in claim 15 including machine executable instructions that are executable by the processor to determine the hidden neuron contribution score for a case instance comprises:
determine, for each hidden neuron, a weight assigned to the last hidden layer corresponding to the case instance;
determine an output of each hidden neuron for the case instance;
compute a mean value of the output for each hidden neuron; and
determine the hidden neuron contribution score for the case instance based on the weight, the output, the mean value of the output, for each hidden neuron in the last hidden layer for the case instance.

19. The non-transitory computer readable medium as claimed in claim 15 including machine executable instructions that are executable by the processor to analyze the second data record comprises applying the first data record neural network to the second data record to determine a corresponding hidden neuron contribution score.

20. The non-transitory computer readable medium as claimed in claim 15 including machine executable instructions that are executable by the processor to generate the plurality of clusters comprises building a clustering model based on hidden neuron contribution scores to provide the plurality of clusters, wherein the clustering model is to group instances having similar hidden neuron contribution scores together.
